(19) United States
(12) Patent Application Publication
(10) Pub. No.: US 2013/0043330 A1
(43) Pub. Date: Feb. 21, 2013

(54) FUEL ATOMIZER AND FUEL INJECTOR HAVING A FUEL ATOMIZER

(71) Applicant: Murray Bruce CORLESS, Springfield (CA)

(72) Inventor: Murray Bruce CORLESS, Springfield (CA)

(21) Appl. No.: 13/100,539

(22) Filed: May 4, 2011

Related U.S. Application Data
(60) Provisional application No. 61/331,113, filed on May 4, 2010.

(51) Int. Cl. B05B 1/26; F02M 57/04

(52) U.S. Cl. 239/418; 239/584

(57) ABSTRACT

The present invention relates to fuel atomizers and fuel injectors capable of being configured to atomize fuel for internal combustion engines. A fuel atomizer for engagement to a fuel injector comprises a nozzle and one or more stacked wafers disposed within the nozzle. The nozzle has an input aperture adapted to engage an outlet of a fuel injector, an output aperture for discharging fuel injected by the fuel injector, and an air supply aperture for receiving air into the nozzle. The wafers are adapted to enable received air to impart energy on the fuel injected from the fuel injector and to enable the fuel to be discharged from the output aperture. A fuel injector capable of being configured to atomize fuel is also provided, in which a fuel injector body is configured to output a fuel spray and the fuel atomizer nozzle discharges the fuel spray.

### CROSS REFERENCE TO RELATED APPLICATIONS

This application claims priority to U.S. provisional application Ser. No. 61/331,113, filed May 4, 2010, which is incorporated herein by reference in its entirety.

### FIELD OF THE INVENTION

The present invention relates to fuel injectors for internal combustion engines. The present invention more specifically relates to fuel atomizers and fuel injectors capable of being configured to atomize fuel for internal combustion engines.

### BACKGROUND OF THE INVENTION

Fuel injection systems mix fuel with air in internal combustion engines. It is important to provide and maintain a particular air/fuel mixture to optimize the efficiency of an engine. In typical internal combustion engines, fuel injectors balance a fuel mixture of various molecular sizes to provide a portion of vaporized fuel which burns initially and a portion of liquid fuel which burns dining and after the initial burn. This balance provides a repeatable ramp-up to pressure and a cooler and wetter initial burn. The balance points are constantly altered due to the effects of changing pressure and temperature during operation of the engine.

FIGS. 1 and 3A illustrate a typical fuel injector for an internal combustion engine. The fuel injector 10 is mounted to each branch pipe of the intake manifold of an engine. The fuel injector 10 is directed to the intake valve of each cylinder. The fuel injector 10 injects a fuel stream 12 from the injector's nozzle, which comes into contact with an air stream 11 after the fuel stream 12 has been injected into the engine. Fuel and air enter simultaneously as the intake valve opens. The fuel injectors are mounted in the intake manifold of the engine so that they spray fuel directly at the intake valves. A fuel rail pipe supplies pressurized fuel to all of the fuel injectors.

FIG. 2 illustrates a pressure profile for a typical fuel injector. The pressure profile 13 experienced during compression and combustion strokes has output energy nominally equal to the right hand side of the profile minus the left hand side of the profile. The maximum pressure 21 can be attained after a certain delay 22 after top-dead-centre (TDC). Irregularities occur at 33 when the liquid portion of the supplied fuel is primarily burnt.

Typically, fuel energy available in an internal combustion engine is consumed or lost approximately as: 22% conversion to mechanical energy (kinetic energy); 6% to mechanical losses (such as friction); 38% to exhaust heat losses; and 34% to coolant losses.

Normal leaning out of the traditional mix (reduction of the proportion of fuel in the air/fuel mixture) primarily reduces the expected liquid portion because of the limited available heat for evaporation and results in a hotter burn and higher pressure with questionable results to the engine, including excessive permanent piston and engine damage.

Fuel atomization has been presented to increase efficiency by reducing fuel consumption while retaining mechanical energy conversion. Fuel atomization systems create finer particles of the fuel as it is injected. The particles have greater surface area than non-atomized fuel. Increased surface area correlates to a greater portion of vaporized fuel, which results in increased efficiency.

U.S. Pat. No. 5,220,900 to Wakeman discloses an air assist atomizer for a fuel injector. The atomizer fits over the outlet of the fuel injector and comprises a thimble-shaped inner part that nests within a thimble-shaped outer part. Both inner and outer parts comprise holes in their end walls through which injected liquid fuel from the injector outlet passes. The inner and outer parts cooperatively define passages through which assist air is conveyed to the aforementioned holes to aid in the atomization of the injected fuel. A pressure differential across the atomizer assembly is effective to cause air to enter air channels and acts on the fuel spray to assist in atomization of the liquid fuel entering the induction passage. The atomizer assembly can be used on conventional fuel injectors.

U.S. Pat. No. 5,174,505 to Shen discloses an air assist atomizer for a fuel injector. The atomizer is a cap-shaped shroud that contains a flat stamped metal insert. When assembled onto the nozzle of a fuel injector, the atomizer causes the insert to be axially sandwiched between the shroud's end wall and the exterior end of the nozzle. In the zone of sandwiching, the insert has circumferential discontinuities that in cooperation with the nozzle end and the shroud's end wall define air assist openings for the assist air to flow radially inwardly toward the injected fuel that has just been injected from the nozzle. The insert is in the form of disks that are flat and of uniform thickness. It comprises a central circular void that is surrounded by a circular annulus which contains at least one circumferential discontinuity. Assist air enters each opening from the discontinuity which is in communication with the inner downstream end of a passage means.

U.S. Pat. No. 5,577,666 to Shen discloses air assist atomizer for a split stream fuel injector. The atomizer is a cap-shaped shroud that contains a flat stamped metal insert. When assembled onto the nozzle of a fuel injector, the atomizer causes the insert to be, axially sandwiched between the shroud's end wall and the exterior end of the nozzle. In the zone of sandwiching, the insert has six channels of circumferential discontinuities that in cooperation with the nozzle end and the shroud's end wall define air assist openings for the assist air to flow radially inwardly toward the injected fuel that has just been injected from the nozzle. The six channels are divided into one set of two each angularly spaced channels that are directed to one of the two axis of fuel flow; another set of two each angularly spaced channels that are directed to the other of the two axis of fuel flow; and two diametrically opposed channels lie along a diameter of the disk that is normal to and bisects a diameter that passes through the two axis of the fuel flow. The insert includes a thin disk orifice member. The disk has a central circular aperture located on its axis of rotation and spaced circumferential discontinuities to receive air for forming an air curtain between the fluid flow streams.

U.S. Pat. No. 5,785,251 to Wood et al. discloses an air assist fuel injector. A shroud member is snapped on the outside of the valve body to provide a path for assist air to atomize the fuel exiting the injector. Located on the bottom surface of the shroud is a belleville washer to preload air deflection disks against the bottom of the valve body. Snap-on connectors cooperate with the valve body to locate and retain the shroud to the valve body.

U.S. Pat. No. 6,499,674 to Ren discloses an air assist fuel injector with multiple orifice plates. The fuel injector includes a multi-layer orifice plate assembly located at the housing outlet. The orifice plate assembly includes a first orifice plate having a plurality of first openings extending therethrough and a second orifice plate disposed proximate to the first orifice plate. The second orifice plate includes a first face having a perimeter, and a plurality of channels extending radially therethrough to the longitudinal axis. The second orifice plate also includes a second face disposed opposite the first face and a plurality of second openings extending between the first face and the second face. The fuel injector also includes an air assist sleeve disposed about the housing proximate to the outlet. The air assist sleeve includes at least one air channel, in communication with the plurality of channels. A method of providing a fuel/air mixture is also provided.

U.S. Pat. No. 6,095,437 to Nozawa et al. discloses an air-assisted type fuel injector for engines. The fuel injector comprises an injector body and an air assisting adapter. The adapter is attached to the injector body and has a fuel passage for guiding spray of injected fuel. The fuel passage is divided into two directions. A plurality of air introduction holes are communicated with the fuel passage, so that pressurized air is introduced into the fuel passage to atomize the injected fuel. The air introduction holes open to the passage at a position where the particle size of the injected fuel starts to reduce. This position is 4 mm to 5 mm away in the downstream direction from an injection port plate of the injector body.

These prior art solutions provide fuel atomizers that can be used with vacuum or pressurized air with one or two deflection disks, orifice plates, or other wafers. These solutions require a high pressure differential between ambient air and pressurized air in order to provide optimal results, requiring either (i) compressed air or a volume of air that could be beyond the engine's low speed requirements; or (ii) a system for recirculating the air from the intake to the fuel atomizer at the expense of energy.

What is required, therefore, is a fuel atomizer or fuel injector capable of being configured to atomize fuel that requires a relatively lower pressure differential between ambient air and pressurized air.

### SUMMARY OF THE INVENTION

In one embodiment of the present invention, a fuel atomizer for engagement to a fuel injector is provided, the fuel atomizer comprising: (a) a nozzle having: (i) an input aperture adapted to engage an outlet of a fuel injector and receive fuel from said fuel injector, (ii) an output aperture for discharging the fuel received from said fuel injector, and (iii) an air supply aperture for receiving air into the nozzle; and (b) one or more wafers disposed within said bore, each wafer adapted to enable said received air to impart energy on the fuel received from said fuel injector and to enable said fuel to be discharged from said output aperture as an atomized fuel spray.

In another embodiment, a fuel injector capable of being configured to atomize fuel is provided, the fuel injector comprising: (a) a fuel injector body configured to output fuel; (b) a nozzle having: (i) an input aperture adapted to engage an outlet of the fuel injector body and receive said fuel, (ii) an output aperture for discharging the fuel, and (iii) an air supply aperture for receiving air, said air supply aperture disposed along a wall of said nozzle between said input aperture and output aperture; and (c) one or more stacked wafers disposed within said nozzle adjacent to said output aperture, each wafer adapted to enable said received air to impart energy on said fuel to enable said fuel to be discharged from said output aperture as atomized fuel spray.

In another embodiment, the present invention provides for a fuel injector comprising: (a) a fuel injector body having an outlet configured to output fuel, said fuel injector body adapted for mounting to a mounting aperture through a wall of an intake manifold of an engine; (b) a nozzle having: (i) an input aperture adapted to engage an outlet of the fuel injector body and receive said fuel, (ii) an output aperture for discharging the fuel, wherein said nozzle is adapted to extend from said mounting aperture into the intake manifold when the input aperture engages the fuel injector mounted on said mounting aperture, such that the output aperture lies relatively closer to an intake valve of the engine.

In another embodiment, the present invention provides for a wafer for a fuel atomizer, wherein said wafer comprises (i) a body having a hollow core and (ii) a shoulder disposed along a, portion of said body, wherein said body is thinner than said shoulder to define a recess between said hollow core and said shoulder.

### DESCRIPTION OF THE DRAWINGS

The invention will be better understood and objects of the invention will become apparent when consideration is given to the following detailed description thereof. Such description makes reference to the annexed drawings wherein:

FIG. 1 illustrates a typical prior art fuel injector for an internal combustion engine.

FIG. 2 illustrates a pressure profile for a typical prior art fuel injector.

FIG. 3A illustrates a prior art fuel injector system.

FIG. 3B illustrates a fuel injector system according to one embodiment of the present invention in an engine.

FIG. 3C illustrates a fuel injector system according to one embodiment of the present invention in an engine.

FIG: 4A illustrates a fuel injector-system in accordance with one embodiment of the present invention.

FIG. 4B illustrates an exploded, cross-sectional view of the fuel atomizer in a fuel injector system in accordance with one embodiment of the present invention.

FIG. 5A illustrates a cross-sectional lateral view of a plurality of wafers within a wafer retainer seated within a fuel atomizer in accordance with one embodiment of the present invention.

FIG. 5B illustrates a cross-sectional lateral view of a plurality of wafers within a wafer retainer seated within the fuel atomizer.

FIG. 6A illustrates a pressure profile for a typical fuel injector.

FIG. 6B illustrates a predicted pressure profile obtained with a fuel atomizer in accordance to one embodiment of the present invention.

FIG. 7 illustrates an engine supply arrangement for the fuel and air supply to the fuel injector system in accordance with the present invention.

FIG. 8A illustrates top, cross-sectional view of a fuel atomizer showing a wafer within the fuel atomizer in accordance with one embodiment of the present invention.

FIG. 8B is a cross-section along lines 8B of FIG. 8A illustrating a plurality of wafers within a wafer retainer seated within a fuel atomizer in accordance with one embodiment of the present invention.

FIG. 8C illustrates a perspective view of stacked wafers in accordance with one embodiment of the present invention.

FIG. 9A illustrates a top view of the wafer of FIG. 8A.

FIG. 9B illustrates a top view of a wafer in accordance with one embodiment of the present invention.

FIG. 9C illustrates a profile view of the wafer of FIG. 9A.

FIG. 9D illustrates a lateral, cross-sectional view of a plurality of wafers within a fuel atomizer in accordance-with one embodiment of the present invention.

FIG. 9E illustrates a top view of a wafer in accordance with one embodiment of the present invention.

FIG. 9F illustrates a lateral, cross-sectional view of a plurality of wafers within a fuel atomizer in accordance with one embodiment of the present invention.

FIG. 10 illustrates a sample circuit schematic that may be used to override the injector signals without affecting the vehicle perception of correct events as the ECU would interpret.

FIG. 11 illustrates a lateral view of a fuel injection system in accordance with one embodiment of the present invention within an engine.

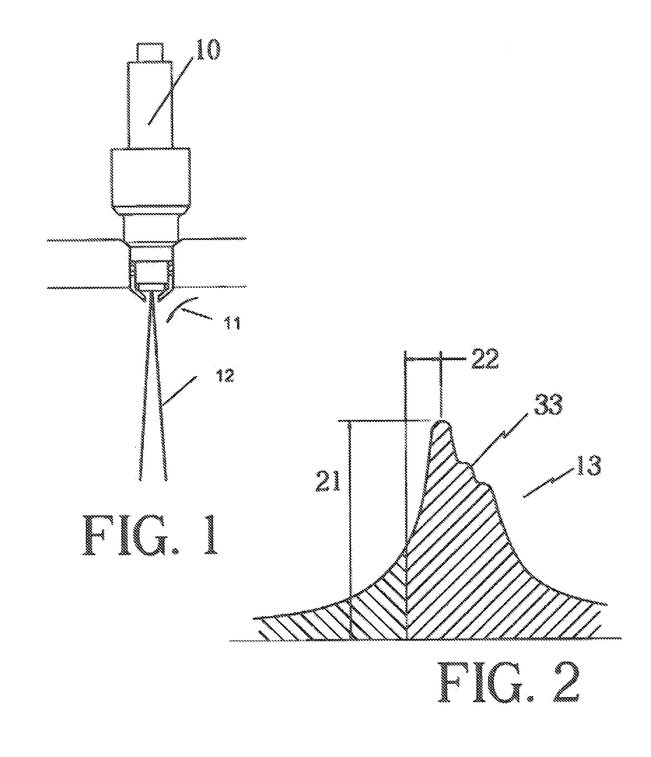

In the drawings, embodiments of the invention are illustrated by way of example. It is to be expressly understood that the description and drawings are only for the purpose of illustration and as an aid to understanding, and are not intended as a definition, of the limits of the invention.

### DETAILED DESCRIPTION

Unless defined otherwise, all technical and scientific terms used herein have the same meaning as commonly understood by one of ordinary skill in the art to which this invention belongs. Also, unless indicated otherwise, except within the claims, the use of “or” includes “and” and vice-versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise.

The invention will be explained in details by referring to the figures.

The present invention provides a fuel atomizer or fuel injector which may be capable of being configured to atomize fuel for an internal combustion engine operable with gasoline or alternative fuels. The fuel atomizer of present invention may be provided as a nozzle for an existing fuel injector or may be adapted as a fuel injector system. The fuel atomizer of the present invention may include an air supply and one or more wafers which allow at to impact the fuel from the injector thereby imparting energy upon injected fuel. The air to the fuel atomizer, for example, may be muted from after the intake filter and mass airflow (MAF) sensor, but before the IAC (Idle Air Control) valve. With nominally about 70 to 90% of the air directed to the fuel atomizer prior to the IAC, maximum available pressure differential would be available at the fuel atomizer, while still having the IAC function normally albeit at a different position. Alternatively, a distributor may be placed prior to the fuel atomizer allowing the available air volume to be directed to only one fuel injector at a time. In a turbo charged or supercharged engine, an air compressing means may be necessary to provide pressurized air into the fuel atomizer.

The fuel atomizer of the present invention may use the available pressure differential between ambient air and the air intake to the cylinder corresponding to the fuel atomizer. The ambient air introduced to the fuel atomizer may impart energy upon the injected fuel. The energy imparted may result in atomization of the fuel particles, thereby increasing the surface area of the fuel relative to a non-atomized fuel spray. The more fuel particles that may be produced per quantity of fuel, the higher the surface area of the fuel for evaporation.

The amount of fuel evaporation may be limited by the amount of energy available in the injected air and fuel. By pre-heating the injected air and/or fuel, further fuel evaporation may be obtained. Alternatively, a reduced mixed temperature of the injected air and fuel into the cylinder may be provided. The result of more evaporative cooling reduces the effective temperature of the injected air and fuel entering the cylinder, hence providing denser air in the cylinder. This denser air supply may increase the volumetric fill of the cylinder resulting in a higher explosive pressure in the cylinder.

By directing this injected air/fuel mix as close as possible to the engine's cylinder intake valve, the vacuum of the intake is optimized for the evaporation of the fuel and minimizes the potential for surface contact of the small particles which in turn would re-collate.

The fuel atomizer of the present invention may use the low pressure difference of the available vacuum to impart energy on the fuel spray, rather than the prior art solutions requiring either (i) compressed air or a volume of air that could be beyond the engine's low speed requirements; or (ii) a system for recirculating the air from the intake to the fuel atomizer at the expense of energy.

The burn (or combustion) results/efficiency experienced with a fuel injector in accordance with the present invention may provide a fuel reduction while delivering equal or greater mechanical energy relative to a typical fuel injector arrangement. This may provide a substantially cooler exhaust, a cooler engine coolant temperature, and substantially reduced emissions, particular nitrogen oxide which is usually associated with higher temperatures. By means of the present invention, existing vehicle components may be reduced or eliminated. One such example may be a radiator.

The present invention, in various aspects thereof, (1) may enhance atomization of fuel spray from a fuel injector to increase surface area; (2) may enhance available energy to the fuel to improve evaporation; (3) may direct the fuel spray to the intake valve so as to optimize efficiency; (4) may enhance control for short term power and improved fuel economy; and (5) may provide less burnt fuel, which may results in less cooling requirement, better emissions, which may in turn may bring the elimination or reduction of a catalytic converter.

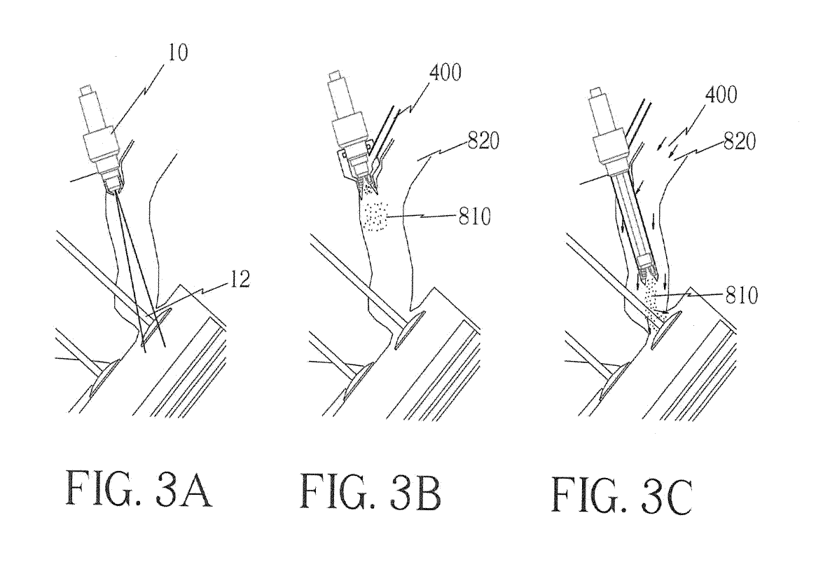

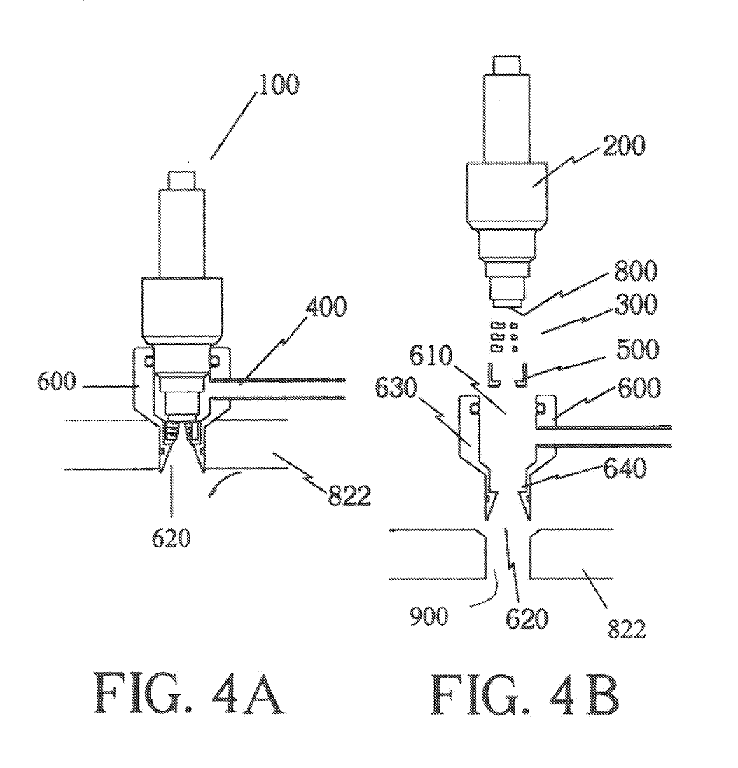

FIGS. 3B, 4A, 4B and 5A illustrate a fuel injector system in accordance with one embodiment of the present invention. With reference to FIGS. 4A and 4B, the fuel injector system 100 may include a fuel atomizer comprising a nozzle 600 adapted for engagement to a fuel injector 200. The fuel injector may be provided as part of the fuel injector system or the fuel atomizer may be engaged to a typical fuel injector provided separately. The fuel injector system may be seated within a mounting aperture 900 formed through a wall of a branch pipe of the intake manifold of engine 822. The mounting aperture 900 may be optimally sized to engage the nozzle 600, for example having about the same diameter if the nozzle 600 is tubular, cylindrical or frustoconical. The nozzle 600 may be fixed though upper and lower seal members to the branch pipe.

With reference to FIGS. 4A and 4B, the nozzle 600 may include a housing 630 having a bore therethrough. The bore may extend from an input aperture 610 adapted to engage the fuel injector 200 at or near its face 800 to an output aperture 620 for discharging the fuel. The fuel injector 200 injects fuel through one or more orifices (not shown) defining an orifice pattern on its face 800.

With reference to FIGS. 4A and 4B, the nozzle 600 may also include an air supply aperture 400 for supplying ambient air into the nozzle 600. The air supply aperture 400 may be disposed along a wall of the nozzle 600. In one aspect, the air supply aperture 400 may be disposed substantially between the input aperture 610 and the output aperture 620. The air supply aperture 400 allows ambient air to be sucked into the nozzle 600 for impacting the injected fuel and thereby imparting energy upon the injected fuel. The energy imparted on the injected fuel causes the injected fuel to atomize, providing an atomized injected fuel spray 810 to be discharged from the fuel injector system. The atomized injected fuel spray 810 may then mix with air from the engine intake 820, which may further increase the velocity of the atomized fuel.

With reference to FIGS. 4A and 4B, the nozzle 600 may also include one or more wafers, thin discs or washers 300. The one or more wafers 300 may be seated within the housing 630 substantially transversely to the bore 640 of the housing 630 or within a wafer retainer 500 seated within housing 630 substantially transversely to the bore 640 of the housing 630. Preferably, the wafer retainer 500 may be adapted to align and position the one or more wafers 300 to optimize energy imparted by air on the fuel spray, as will be discussed more fully below.

With reference to FIGS. 4A, 4B, the wafers 300 and wafer retainer 500, if used, may be seated in the bore substantially transversely thereto between the input aperture 610 and the output aperture 620 below the fuel injector 200 in the nozzle 600. The wafer retainer 500 may be slightly smaller in diameter than the surface of bore defined by the housing 630 and slightly larger in diameter than the wafer 300. The wafer retainer 500 may by cylindrical and have an open top and generally open bottom with a retaining lip.

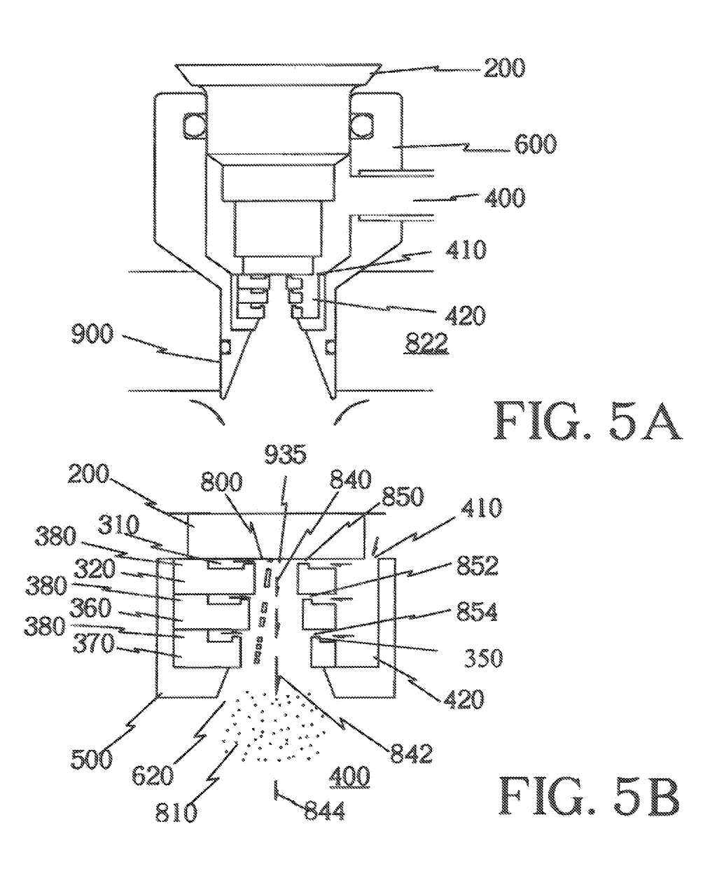

FIG. 5B illustrates a cross-sectional, lateral view of a plurality of wafers 320, 360, 370 within a wafer retainer 500 seated within the nozzle 600. A passage defined by a gap formed between the fuel injector 200 and the inner wall of the nozzle 600 defines an air channel or passage 410, as shown in FIGS. 5A and 5B. The air channel 410 may direct or channel ambient air from air supply aperture 400 toward void 420 and then to the fuel spray injected from a face 800 of the fuel injector 200. The fuel spray discharged at the face 800 has an initial velocity V0 840.

A first wafer 320 may be seated substantially below the face 800 of the fuel injector 200. Optionally, one or more subsequent wafers 360, 370 may be seated below and substantially aligned with the first wafer 320. Each of the wafers cooperate with one another to provide an air gap 850, 852, 854 with the preceding wafer (or, in the case of the first wafer 320, the face 800 of the fuel injector) and a void in the subsequent wafer (or, in the case of the last wafer 370, the retainer 500 or the nozzle 600). It should be understood that any number of wafers may be included for defining any number of air gaps.

Ambient air which may be directed from the air channel 410 into the bore 640 of the nozzle 600 or, if provided, into the retainer 500 may be dispersed around the wafers 300 by a void 420 formed in the nozzle 600 or retainer, if one is included, around the wafers. Air gap 850 may enable air from the void 420 to be passed to the face 800 of the fuel injector to impart energy on the fuel spray. Subsequent air gaps 852 and 854 may enable air from the void 420 to be passed through the wafers to impart further energy on the fuel spray. For example, each wafer may include at least one recess along at least one surface that cooperate to form air gaps 850, 852 and 854 to allow air from the void 420 to pass along the surface toward the fuel spray. Air from the void 420 may be dispersed around the gaps 850, 852, 854 via a recess 310 on each wafer.

The wafers may be adapted to substantially self-align with one another and with the nozzle or retainer. The wafers may be coupled to the nozzle's housing using a press fit or may also be built into the nozzle's housing. Each wafer may include a main body and a periphery. With reference to FIG. 5, the wafer's periphery may define a shoulder 380. Shoulder 380, for example, may hold the wafers in position and alignment relative to the other wafers, including by maintaining the air gap. A side of shoulder 380 may contact the inner surface of the nozzle 600 or retainer 500, if used. The shoulder 380 may define a thick portion of the periphery of the wafer while the body may define a thin portion of the wafer. If a plurality of wafers is provided, each of them may have different shoulder and body thicknesses.

In FIG. 5B, for example, three wafers 320, 360, 370 are included. The wafers 320, 360, 370 may be substantially stacked one upon the other at their shoulders 380. The stacked bodies, due to having less thickness than the shoulders 380, may define the one or more air gaps 850, 852 and 854 through which ambient air may be directed by air channel 410 and occupying the void 420 may pass to impart energy upon the fuel spray injected from the face 800 of the fuel injector 200.

It should be noted that each air gap 850, 852 and 854 may be a different dimension than others or they may have substantially equal dimensions.

With reference to FIG. 5B, each wafer 320, 360, 370 may;be hollow at its core so as to define a passage therethrough. In one embodiment, the hollow core may be at least as wide as the orifice pattern on the face 800 of the fuel injector 200 so as to not impede the path of the fuel spray. In another embodiment the hollow core may have a width that is less than the orifice patter on the face. In this case a relatively small impact of the fuel may assist in slowing the velocity of the injected fuel. Each wafer may have different hollow core sizes to accommodate the increasing diameter of the fuel spray as it travels from the fuel injector through the retainer and nozzle and out the output aperture.

A ridge 350 may be included on the wafer at the periphery of the hollow core so as to define an annular recess along the surface of the wafer 320, 360, 370. The annular recess may enable air to spread out evenly around the hollow core without excessive pressure loss to create a substantially even discharge pressure. The ridge 350 may extend lower than the shoulder 380 so as to define the air gap 850, 852 and 854. Air may be channeled from the void 420 around the annular recess and through the air gap 850, 852 and 854. The air entering the hollow core from the air gap 850, 852 and 854 may impart energy onto the fuel spray.

The combined air/fuel mixture may become atomized as it progressively advances through the nozzle 600 while being continuously impacted by air passing from successive air gaps 850, 852 and 854. The air/fuel mixture is discharged from the output aperture 620 of the, nozzle 600 with a discharge velocity 842 that is greater than the initial velocity V0. At the point of discharge from the nozzle 600, air in the engine air intake 820 mixes with the air/fuel mixture resulting in a further increase in velocity 844 that satisfies the engine demand for mixed fuel when an intake valve in the engine 822 is opened.

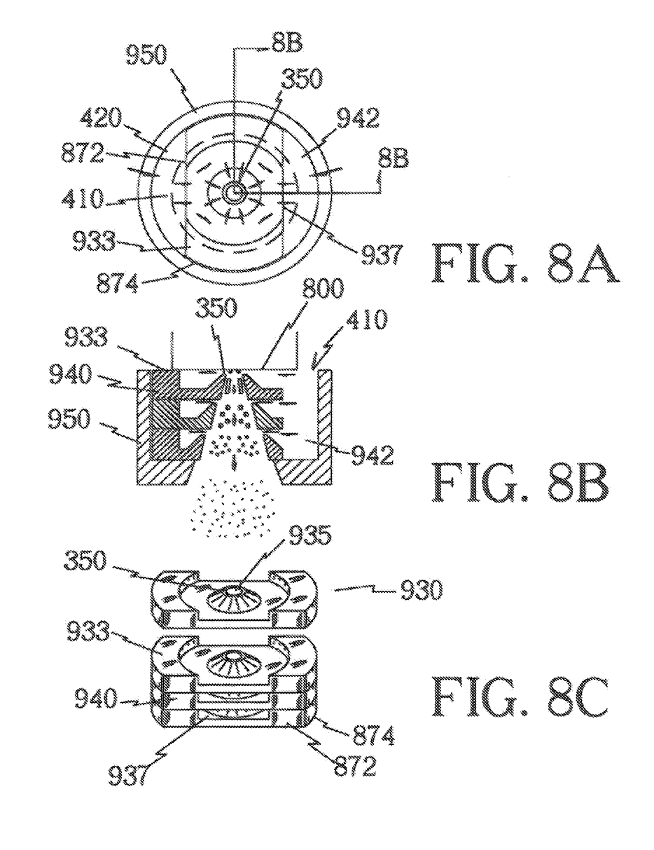

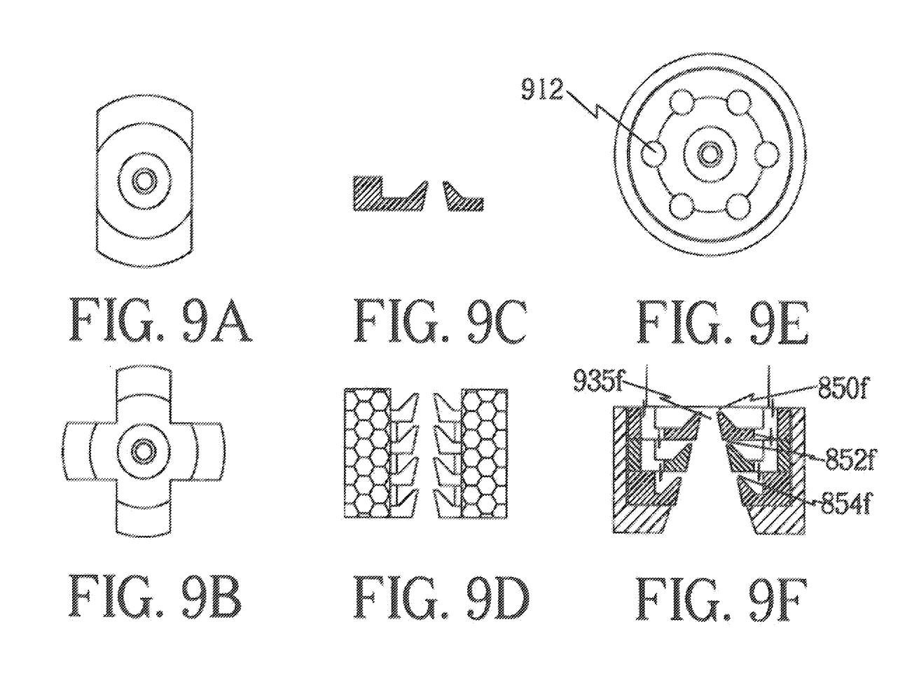

FIGS. 8 and 9A illustrate one embodiment of a wafer in accordance with the present invention. The wafer 933 may engage with a portion of the inner wall of the nozzle 960 or retainer 950 if used. The remaining portion of the nozzle 960 or retainer 950, if used, not engaging the wafer 930 defines the void 942.

The periphery of each wafer may include two parallel sides 872 joined by curved sides 874. Each wafer 933 may be hollow at its core 935 so as to define a passage therethrough. In the embodiment shown in FIG. 8 the hollow core 935 may be at least as wide as the nozzle orifice pattern on the face 980 of the fuel injector so as to not impede the path of the fuel spray. As seen particularly in FIG. 8B, each wafer may have different hollow core 935 sizes to accommodate the increasing diameter of the fuel spray as it travels from the fuel injector out of the retainer 950 and nozzle 960.

A ridge 935 may be include on the wafer at the periphery of the hollow core 935 so as to define an annular recess along the surface of the wafer 934. The annular recess may enable air to spread out evenly around the hollow core 935 without excessive pressure loss to create a substantially even discharge pressure. The ridge 935 may extend lower than the shoulder 933 so as to define the air gap. Air may be channeled from the void 942 around the annular recess 937 and through the air gap. The air entering the hollow core 935 from the air gap may impart energy onto the injected fuel spray.

FIGS. 9B to 9F illustrate further embodiments of the wafers. FIG. 9B illustrates a wafer similar to that shown in. FIG. 9A however the wafer of FIG. 9B occupies more space than that of FIG. 9A by having a substantially cross shaped top view. FIG. 9C illustrates a profile view of the wafer of FIG. 9A. FIG. 9D illustrates a unit comprising multiple wafers based on a composite material that includes a porous body for positioning and channeling air with an insert at the point of interface with the fuel injector. FIGS. 9E and 9F depict wafers having another system of passages to channel air forward to additional wafers when stacked. In this embodiment the wafer may take a substantially disk shape covering the entire bore of the nozzle such that there is no void being provided such as for example void 942 of FIG. 8. The wafers may include a series of apertures 912 through the main body of the wafer which may direct air from air channel to an annular recess around core 935f and through air gaps 850f, 852f and 854f. The air entering air gaps 850f, 852f and 854f may impart energy onto the fuel spray.

The present invention, in another aspect, also enhances control for short term power and improved fuel economy in existing engines. Alternatively, engines that can handle high pressures could be adapted for use with the present invention.

The need for enhanced controls arises due to increased pressure caused by the present invention. An engine's efficiency is typically best when a high vacuum is created, which occurs during idle and cruise conditions. The higher pressure in the cylinders generally occurs at load and low vacuum conditions, and it is at these times that an air assist by vacuum has little to no effect on performance. A fuel injector in accordance with the present invention may result in fuel explosions causing a much higher pressure in the engine if using typical control data tables. Thus it may be preferred or required to modify the control data tables to accommodate the benefits of the present invention, therefore not requiring any physical upgrades to the engine.

An air distributor linked to the engine cycle may be provided for selectively enabling and disabling channeling of ambient air to a particular fuel atomizer. A stepper motor coupled to the air distributor may be linked to the firing sequence of the engine cycle for providing timing of enabling and disabling channeling of ambient air to each fuel atomizer. As each fuel atomizer in operation may require more air than is consumed by its corresponding cylinder, the channeling of ambient air to the particular fuel atomizer is optimally disabled when fuel is not being injected to the cylinder. In a test, it was shown that an arrangement of three wafers in accordance with the present invention along with the air distributor and stepper motor apparatus resulted in 90% of idle air, through each nozzle, no surface wetting, and dry at 9 inches with a high speed discharge.

Furthermore, existing controls may provide an air to fuel ratio (AFR) of, for example, 14.7:1, whereas in the present invention an AFR may be controlled at anywhere between about 14.7:1 to about 30:1. It should be understood that particular ratios are dependent upon the particular engine with which the fuel atomizer is implemented.

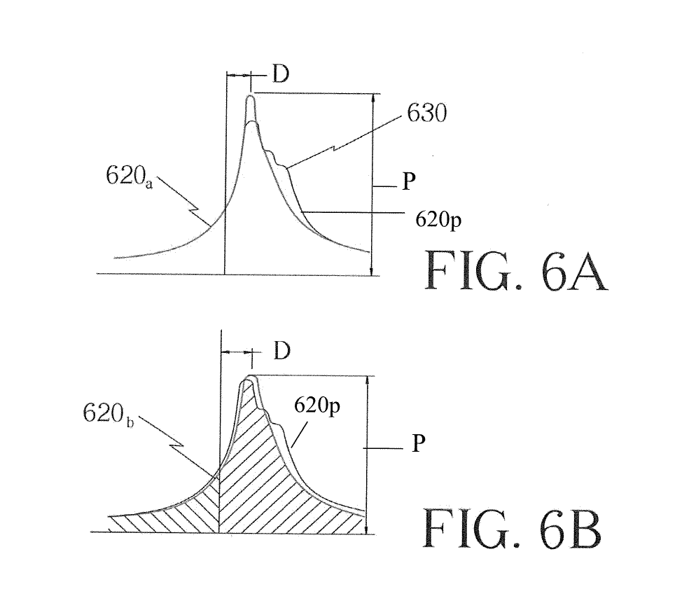

FIGS. 6A and 6B illustrate predicted pressure profiles 620a and 620b for a fuel atomizer system of the present invention relative to the prior art pressure profile 620p. The prior art pressure profile 620p curve around the top-dead-centre between the compression and combustion strokes. The maximum pressure P of prior art pressure profile 620p occurs to the right of TDC by D. Prior art curve 620p includes a region 630 of secondary burning. Pressure profile 620a depicted in FIG. 6A, may represent a predicted pressure profile curve for a fuel atomizer system of the present invention. The maximum pressure of curve 620a is depicted as being higher than 620p. FIG. 6B depicts a predicted pressure profile 620b of a fuel atomizer system of the present invention which has a delay in TDC at D, which may lower the pressure within the engine's maximum threshold. The relevant energy output RH-LH of 620b may be similar to that of 620p without detriment to the engine, as shown in FIG. 6B. This delay may be achieved, for example, by delaying the advance for the spark.

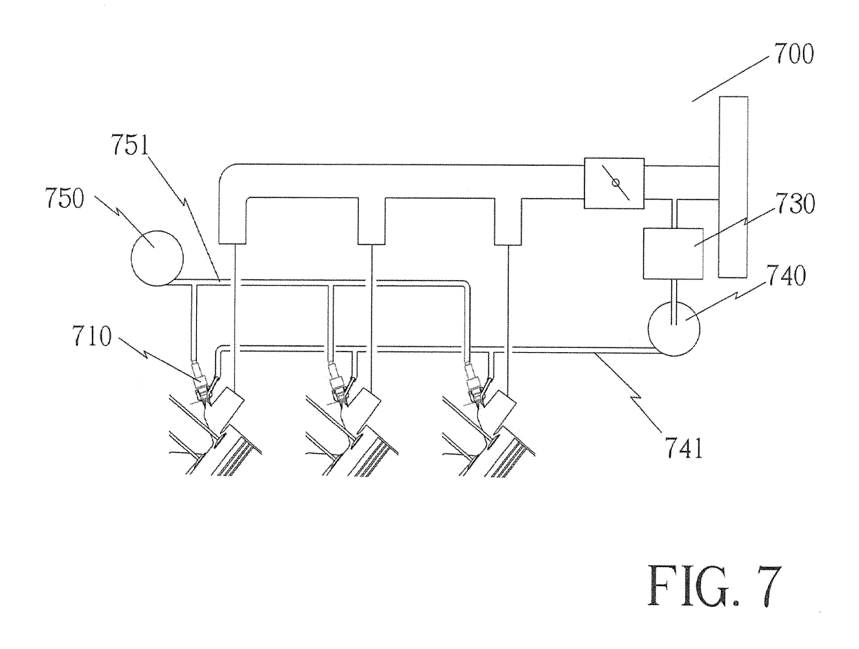

FIG. 7 illustrates an engine supply arrangement 700 for the fuel and ambient air supply to the fuel injector system in accordance with the present invention. The fuel supply may include a pump 750 and distribution system 751. The ambient air supply to the nozzles may be obtained from the engine intake and distributed through an auxiliary heater 730 and passive heater 740. The ambient air supply may then be directed through a delivery header 741 to the air supply aperture of each fuel injector system 710.

As mentioned above, by directing the injected air/fuel mix as close as possible to the engine's cylinder intake valve, the vacuum of the intake is optimized for the evaporation of the fuel and minimizes the potential for surface contact of the small particles which in turn would re-collate. Accordingly, it may be advantageous to bring the injected fuel relatively closer to the entry point into the cylinder and substantially in the middle of the incoming air stream. As such, in one embodiment of the present invention, an extension means may be added to a fuel injector which may extend from the mounting aperture formed through a wall of the branch pipe of the intake manifold in the engine where the fuel injector may be seated, into the inside of the branch pipe of the intake manifold, thereby bringing injected fuel relatively closer to the entry point into the cylinder intake valve. The extension means may be, for example, a pipe or tube which may take any form, including a substantially cylindrical, substantially tubular or substantially frustoconical form. The extension means may have an end configured for coupling to the fuel injector, and another end which may lie inside the engine's intake manifold and relatively closer to the intake valve. The fuel may then be injected relatively closer to the entry point into the cylinder intake valve. This extension may provide a number of advantages, including, without limitation, creating more space within the fuel injector to include devices such as polarizing coils, or by bringing the fuel atomizer of the present invention to a position within the intake manifold relatively closer to the intake valve.

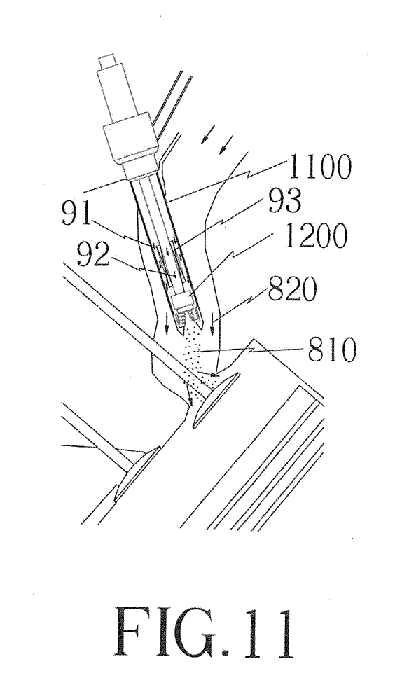

FIG. 11 illustrates another embodiment of the present invention in which the fuel atomizer system of the present invention may include an extension means 1100 such that the atomized fuel cloud may be released relatively closer proximity to the cylinder intake valve. There may be different options for bringing the injected atomized fuel cloud relatively closer to the intake valve. One option may be to maintain the fuel injector at its location mounted on the engine intake manifold and extend a tip of the injector into the intake manifold. Another option may be to bring the nozzle of the fuel injector together with the fuel atomizer of the present invention to a position within the intake manifold relatively closer to the cylinder's intake valve, as shown in FIG. 11. This last option may require modifications to the fuel injector. One modification of the fuel injector may involve relocating the coil and valve means of the fuel injector together with the fuel atomizer of the present invention to a position within the intake manifold relatively closer to the cylinder's intake valve, or it may involve just moving the fuel injector's valve portion together with the fuel atomizer of the present invention to the position relatively closer to the intake valve. The second and third options may result in the formation of an area before the injector's valve which may be available to include fuel polarizing means. There may be advantages the later fuel is polarized within a fuel injector. For example, the later fuel is polarized within a fuel injector, the greater the potential effect of said polarization. Accordingly, greater polarizing effects may be achieved by locating the polarizing means within the intake manifold in accordance with embodiments of the present invention.

The position of the fuel atomizer of the present invention within the intake manifold and relative to the cylinder intake valve may be a compromise between the cloud entrainment in the air and a distance from the intake valve to permit the fuel cloud creation and to optimize air flow around the atomized fuel cloud to further barrier the fuel particles from making contact with one another, or with the walls of the intake valve. The extension means 1100 may take the form of a substantially cylindrical tube having a bore 1120 therethrough. Extension means 1100 may include one aperture at one end adapted for engagement to the fuel injector and another aperture at the other end for discharging the atomized injected fuel. Another extension 1130 from the fuel injector may run coaxially within the bore 1120 of the extension 1100. Injected fuel may run through extension 1130. The fuel atomizer of the present invention may be coupled to an end of extension 1130 for receiving the injected fuel. The fuel received by the fuel atomizer of the present invention may be atomized as explain above and released as atomized injected fuel 810 relatively closer to the intake valve 1140.

In one embodiment, an air to liquid heat exchanger may be added prior to the nozzle air supply header. The liquid heat exchanger may be placed prior to the nozzle air supply header.

As previously mentioned, by relocating the fuel injector's head, which may include the valve and coil of the fuel injector, to a position within the intake manifold, and thus relatively closer to the intake valve, more space is created within the fuel injector. As such, in another embodiment, polarizing coils may be added prior to the injector's head. The polarizing coils may not only serve to polarize the fuel being injected but it may also polarize the nozzle air. FIG. 11 illustrates the location of the polarizing coils 93 relative to the injected fuel 92 and the nozzle air 91. Injector coil may be located at 1200 or located at the open face portion of the valve.

In operation and with reference to FIG. 5B, as fuel is being injected at velocity V0 840 from the orifice pattern on the face 800 of the fuel injector 200 as known in the art, ambient air is channeled to a particular fuel atomizer through air channel 410 into void 420.

The air occupying the void 420 may be dispersed around the wafers 320, 360, 370 by means of ridge 350 and its corresponding annular recess on each wafer. The air may then pass through air gap 850 in substantial proximity to face 800 of the fuel injector 200, imparting energy on the fuel injected from the fuel injector 200. The imparted air may enable the velocity of the injected fuel to be greater than V0 840 and atomizes the fuel.

Air from the void 420 may simultaneously pass through air gap 852 in proximity of the fuel impacted by the air passing through air gap 850. The air passing through air gap 852 may impart further energy onto the injected fuel, enabling the velocity of the injected fuel to increase further from V0 840 and further atomizing the fuel.

Correspondingly, air may pass from the void 420 through air gap 854 and any subsequent air gaps defined by further wafers, which further increases the velocity of the injected fuel and further atomizes the fuel.

The injected fuel, once fully impacted by air passed through the plurality of air gaps, may be discharged from the output aperture 620 of nozzle 600 at velocity VD 842, being greater than V0 840. Subsequent to discharge of the injected fuel from the nozzle 600, air in the engine air intake 400 may mix with the injected fuel resulting in a further increase in its velocity to VM 844, which may satisfy the engine demand for mixed fuel when an intake valve in the engine 822 is opened.

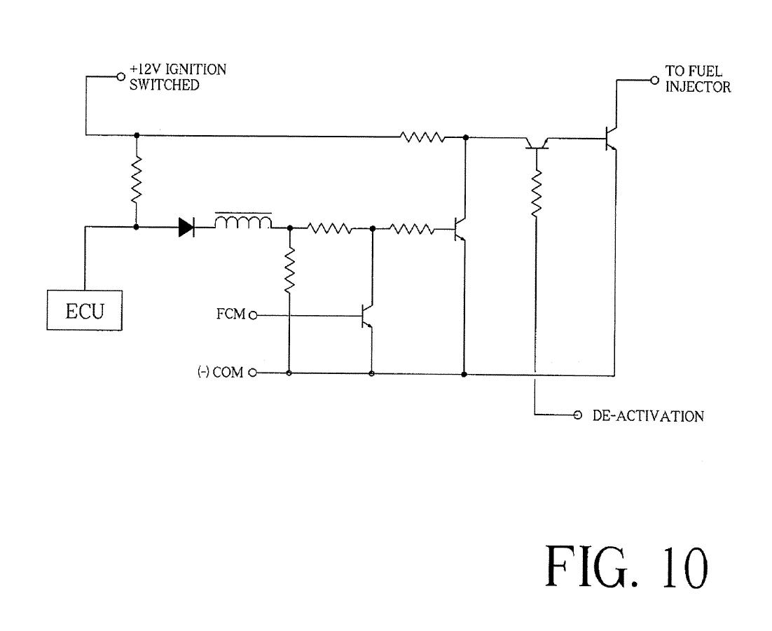

To facilitate the fuel atomizer/fuel injector arrangement and its effects, the existing engine control unit's (ECU) data tables may require to be changed, either by directly modifying the ECU values, or by adding a control module to communicate new information to the. ECU. The new control module may be a Diagnostic. Port used for vehicle evaluation. Tables of note that require changing, relate to inputs from the MAF MAP, Exhaust and temperatures to adjust fuel, timing and IAC. An added feature that the present inventor achieved may be the electronic cycling reduction of used cylinders. This option may not just be a straight forward exchange of data, but requires a controller with the ability to disable signals to the injectors while maintaining the illusion to the ECU, that the injectors are still functioning. FIG. 10 illustrates a circuit which may be capable of interrupting the injector signal.

The above disclosure generally describes the present invention. Changes in form and substitution of equivalents are contemplated as circumstances may suggest or render expedient. Although specific terms have been employed herein, such terms are intended in a descriptive sense and not for purposes of limitation. Other variations and modifications of the invention are possible. As such modifications or variations are believed to be within the sphere and scope of the invention as defined by the claims appended hereto.

1. A fuel atomizer for engagement o a fuel injector, the fuel atomizer comprising:
(a) a nozzle having:
(i) an input aperture adapted to engage an outlet of a fuel injector and receive fuel from said fuel injector,
(ii) an output aperture for discharging the fuel received from said fuel injector, and
(iii) an air supply aperture for receiving air into the nozzle; and
(b) one or more wafers disposed within said nozzle adjacent to said output aperture, each wafer adapted to enable said received air to impart energy on the fuel received from said fuel injector and to enable said fuel to be discharged from said output aperture as an atomized fuel spray.

2. The fuel atomizer of claim 1, wherein said imparted energy increases the velocity of said atomized fuel spray.

3. The fuel atomizer of claim 1, wherein each wafer comprises a body having a hollow core and a shoulder disposed along a portion of said body.

4. The fuel atomizer of claim 3, wherein said body is thinner than said shoulder to define a recess.

5. The fuel atomizer of claim 4, wherein said fuel atomizer comprises a plurality of wafers, wherein said plurality of wafers are stacked one upon the other at their shoulders so as to define a plurality of air gaps defined by their recesses for directing said received air from the air supply aperture to said hollow core.

6. The fuel atomizer of claim 1, further comprising a wafer retainer seated within said bore for retaining said one or more stacked wafers.

7. The fuel atomizer of claim 1, wherein said nozzle includes a bore extending from said input aperture to said output aperture.

8. The fuel atomizer of claim 1, wherein said fuel atomizer is adapted to extend from a mounting aperture through a wall of an intake manifold of the engine into the intake manifold when said fuel injector is mounted on the mounting aperture, such that the output aperture lies relatively closer to an intake valve of the engine.

9. A fuel injector capable of being configured to atomize fuel, the fuel injector comprising:
(a) a fuel injector body configured to output fuel;
(b) a nozzle having:
(i) an input aperture adapted to engage an outlet of the fuel injector body and receive said fuel,
(ii) an output aperture for discharging the fuel, and
(iii) an air supply aperture for receiving air, said air supply aperture disposed along a wall of said nozzle between said input aperture and output aperture; and
(c) one or more stacked wafers disposed within said nozzle adjacent to said output aperture, each wafer adapted to enable said received air to impart energy on said fuel to enable said fuel to be discharged from said output aperture as atomized fuel spray.

10. The fuel injector of claim 9, wherein said imparted energy increases the velocity of said atomized fuel spray.

11. The fuel injector of claim 9, wherein each wafer comprises a body having a hollow core and a shoulder disposed along a portion of said body.

12. The fuel injector of claim 11, wherein said body is thinner than said shoulder to define a recess.

13. The fuel injector of claim 12, wherein said fuel atomizer comprises a plurality of wafers, wherein said plurality of wafers are stacked one upon the other at their shoulders so as to define a plurality of air gaps defined by their recesses for directing said received air from the air supply aperture to said hollow core.

14. The fuel injector of claim 9, further comprising a wafer retainer seated within said bore for retaining said one or more stacked wafers.

15. The fuel injector of claim 9, wherein said nozzle includes a bore extending from said input aperture to said output aperture.

16. The fuel injector of claim 9, wherein said fuel atomizer is adapted to extend from a mounting aperture through a wall of an intake manifold of the engine into the intake manifold when said fuel injector is mounted on the mounting aperture, such that the output aperture lies relatively closer to an intake valve of the engine.

17. A fuel injector comprising:
(a) a fuel injector body having an outlet configured to output fuel, said fuel injector body adapted for mounting to a mounting aperture through a wall of an intake manifold of an engine;
(b) a nozzle having:
(i) an input aperture adapted to engage an outlet of the fuel injector body and receive said fuel,
(ii) an output aperture for discharging the fuel,
wherein said nozzle is adapted to extend from said mounting aperture into the intake manifold when the input aperture engages the fuel injector mounted on said mounting aperture, such that the output aperture lies relatively closer to an intake valve of the engine.
